(19) United States
(12) Patent Application Publication
(10) Pub. No.: US 2015/0290816 A1
(43) Pub. Date: Oct. 15, 2015

(54) PUMP ASSEMBLY

(71) Applicant: Fernando A. Ubidia, Ludlow, MA (US)

(72) Inventor: Fernando A. Ubidia, Ludlow, MA (US)

(21) Appl. No.: 14/253,053

(22) Filed: Apr. 15, 2014

(51) Int. Cl. B25J 15/06; F04C 25/02; B25J 9/00; F04C 18/344

(52) U.S. Cl. CPC B25J 15/0616; F04C 18/3441; F04C 25/02; B25J 9/00; Y10S 901/27; Y10S 901/40

(57) ABSTRACT

The disclosure generally relates to pump assembly that includes a rotary vane vacuum pump. The pump assembly is controlled using a controller and may be moved through manipulation of a robotic arm segment of the pump assembly and a reel and cable segment of the pump assembly. The vacuum pump includes a motor and rotor each offset from the center axis of the body of the vacuum pump. Vanes that are longer than the diameter of the rotor slide within cavities of the rotor and, as the rotor turns, create a vacuum in the vacuum generating chamber of the pump. A bypass groove on the rotor limits thermal expansion and a biasing spring maintains a critical distance between the rotor and an air intake plate to maintain proper vacuum in the vacuum generating chamber.

### CROSS-REFERENCE TO RELATED APPLICATION

Not Applicable

### FEDERALLY SPONSORED RESEARCH OR DEVELOPMENT

Not Applicable.

### FIELD OF INVENTION

The present invention generally relates to a compact vacuum pump that generates high suction, lift and hold. A common application for such a device is for vending machines and similar product dispensing devices where the pump is utilized in conjunction with a manipulator.

### BACKGROUND

Vacuum pumps capable of generating high vacuum and holding force are usually large, expensive and require large motors (hp) to drive the pumps. Positive displacement pumps such as piston, rotary vane, lobed-rotor, rotary screw and rocking piston are capable of generating high vacuum levels. The selection of positive displacement vacuum generating pumps depends on the application since not one single technology can satisfy all applications. Of all the available technologies, rotary vane vacuum generating pumps are most commonly used. Rotary vane pumps generate vacuum in the 10 to 25 inch Hg range.

Rotary vane vacuum generating pumps provide high vacuum levels; however, due to the characteristics of the pump, rotary vane pumps have a low rate of air removal thus generate very low air flow. Due to the low CFM capacity (airflow), rotary vane pumps cannot generate the suction power centrifugal pumps are able to generate and, therefore, rotary vane pumps must make contact with an object, evacuate the air and create a vacuum force to lift and/or move an object. Rotary vane vacuum generating pumps create a high amount of heat. By forcing the vacuum pressure down, heat is generated and the “heat of compression” generated by rotary vane pumps is very high and must be dissipated to prevent damage to the internal components. The pump is very large and heavy, usually made of cast iron, to be able to remove the heat created during the compression cycle. Rotary vane vacuum generator pumps are not suitable for vending machines or similar product dispensing devices because of the size, weight, cost power requirements (hp) and lack of air flow. The vanes in the rotary vane pump are usually of square profile (profile being defined as height vs length) and very small when compared to the overall size of the pump.

For vending machine applications, centrifugal pumps are commonly used. Vacuum generating centrifugal pumps are classified as non-positive displacement pumps and as such they cannot produce high levels of vacuum, they only produce high air flow rates. Lifting capacity is limited by the air flow created and is restricted by the low vacuum levels. Because of the low vacuum capability, centrifugal pumps used in the vending industry are limited to lifting/moving light objects. While centrifugal vacuum generating pumps rely on high air flow to pick up an object, vacuum levels remain low due to the internal bypass and the air flow that is recycled within the ports, blade and housing. To be able to retrieve frozen food items or other vending products, standard centrifugal pump needs to be larger in diameter in order to be able to retrieve the product. This is because a large impeller is needed to create high air velocity and volume to achieve adequate vacuum to pick up products. Vacuum generating centrifugal pumps are typically large, draw high current, create noise, generate low vacuum and have limited lifting capability. For the above listed characteristics, centrifugal vacuum pumps are not ideal or practical for vending machines and/or dispensing of products.

Because of the nature of the product packaging and the fact that the frozen packages often do not have flat surfaces, positive displacement pumps can not be reliably used. On irregular surfaces, the air leakage cannot be overcome by the limited CFM air flow generated by positive displacement pumps such as rotary vane pumps. Accordingly, a new type of vacuum device is required to allow for the manipulation of products where the shape and surface irregularity of the product may not be uniform. The new device creates both high air flow and high vacuum for product retrieval. Additionally, frost and ice buildup, often present in frozen vending applications, pose similar challenges to positive displacement pumps as do irregular surfaces. The frost and ice cause irregular or discontinuous surfaces that positive displacement pumps cannot lift. The high air flow and vacuum produced by the present device allows irregularly shaped items in addition to frozen packages with frost or ice build-up to be lifted.

Prior centrifugal vacuum pumps used in vending machines are rated at 120 volts, 12 amps with a peak of 6.5 horse power creating a vacuum pressure of 4-6 inches of mercury. The motor/pump assemblies are large roughly 6 inches by 6 inches by 8 inches and up to 10 to 15 pounds in weight. Centrifugal vacuum pumps used in vending machines are noisy and require a ramp up time to create pressure and a ramp down time to release pressure. For the proper operation in the vending machine industry, centrifugal pumps require additional components. These include solenoids, air vending devices and pressure switches.

Prior rotary vane pumps operating in the one quarter horse power range utilized 120 volts AC motors. Those motors were generally capable of creating vacuum pressure in the range of 10-20 inches of mercury. The motor/pump assemblies also tended to be large, roughly 20 to 30 pounds, and generated significant heat. For example a one quarter horse power rotary vane motor/pump assembly capable of generating such pressure would have dimension of 6 inches by 6 inches by 11 inches. In typical operation, such motors/pump assemblies would reach upwards of 150 degrees Fahrenheit and include heavy cast iron components to help dissipate the heat generated in the operation of the motor. Additionally, at 10 inches of vacuum, rotary vanes motor/pumps assemblies were only capable of producing around 0.6 cfm.

For vending machine applications, there are generally two methods of utilizing vacuums to vend product. One method is to locate the pump remotely to the picker head. Another method is to utilize a manipulator, such as a robotic arm as shown in U.S. Pat. No. 8,079,494 directed to a Delivery System, the entirety of which is incorporated herein by this reference. For the second application, it is necessary that the pump be both powerful and light weight in order to allow for successful manipulation of the pump while ensuring that enough force is generated to temporarily couple the picker head to a product. Previous pumps often lacked the ability to generate sufficient power to pick up heavier items or oddly shaped items and thus there is a need for a compact and lightweight solution.

In summary, existing rotary vane and centrifugal vacuum generating pumps are not suitable for vending machines and dispensing of products because of size, cost, power requirements, noise and vacuum characteristics.

### SUMMARY OF THE DISCLOSURE

The present apparatus provides a high capacity compact vacuum generating system that produces high vacuum levels and air flow. The combination of both enables the vacuum generating pump to draw the product to the picker tip and hold the product for lift and dispensing. With the higher suction levels, heavier objects and oddly shaped products are now able to be picked up and moved. The existing limitations of centrifugal vacuum generating pumps are now overcome by the present pump. The high capacity compact vacuum generating pump follows the design principals of typical rotary vane pumps except that large vanes are utilized to create both air flow and high vacuum.

The motor/pump assembly associated with the present invention overcomes many of the drawbacks of the prior vacuum motors. The motor is a low power DC motor that is significantly smaller, the motor/pump assembly is generally 2.5 by 2.5 by 7 inches and runs cooler, generally 110-125 degrees Fahrenheit than prior motors. Preferably, the motor is a 24 volt, 4-6 amp DC motor having a 120 watt power rating. The structure of the assembly provides for up to 3 cfm at 10 inches of vacuum, the preferred operating range being 2-3 cfm at 10 inches of vacuum. Additionally, the motor/assembly generates pressures up to 20 inches of mercury, while also operating to generate in the preferred range of 7-10 inches of mercury. The present invention does not require additional components such as solenoids, air venting devices or pressure switches that centrifugal pumps require for vending machine applications.

According to the present design, long, narrow vanes are utilized to increase air flow without increasing the relative diameter of the pump. Using long and narrow vanes gives the present pump the benefit of centrifugal and positive displacement pumps in that it provides higher air flow and high vacuum, respectively, while producing minimal heat. Furthermore, the air flow created by the vane configuration is used to cool the vacuum chamber, and associated components so that no large pump body for heat dissipation is required. Additionally, the center axis of the rotor is offset from the center axis of the vacuum generating cavity. Accordingly, air is drawn into the vacuum generating cavity, is compressed and then exhausted out of the cavity due to the retraction and extension of the vanes within the cavity.

The present pump will also run in stall mode without overloading and damaging the motor and without creating any significant heat. Centrifugal pump and positive displacement pumps (vanes) will run very hot under stall mode and eventually cause damage to the motor. Furthermore, high level of heat dissipation is required in both cases to remove the heat generated under stall conditions. For these reasons, the pump body of a positive displacement pump requires a large mass and surface area while centrifugal pumps require high volumes of air flow to cool the motor. By contrast the present pump achieves higher levels of vacuum at low speed and lower energy usage due to the design of the rotor, vanes and vacuum generating chamber. The pump is efficient in that the target vacuum is achieved almost instantaneously since very little ramp up speed is needed as required.

In addition to the large vanes, the high capacity compact vacuum generating pump includes a self adjusting rotor and a rotor bypass to allow compressed air to be bypassed internally. The bypass reduces the heat of compression of the gas in the pump while maintaining high levels of vacuum and air flow. The operating features of high capacity compact vacuum generating pump enables the vacuum generating device to be configured with lighter materials such as thermoplastics in place of cast iron since heat removal is not as critical due to the configuration of the vacuum generating pump. Because of its features, the high capacity compact vacuum generating pump is light, compact, low cost and requires very low power to operate. The rotor used in the present pump has a groove in one end to allow a precise air bypass. The rotor in the present pump is also self adjusting in that it maintains critical dimensions between the rotor, the intake plate and outlet plate as the rotor and its associated components expand as they are affected by the heat of compression of the gas in the system. The self alignment features of the rotor and the reduced heat of compression due to the rotor configuration enables the pump to run for extended periods of time without any detriment to the materials or the pump performance. Due to the low operating temperatures, the lifetime of the materials of the rotor and its associated components is no longer an issue and the pump does not require the use of large heat sinks for heat dissipation.

Because of the compact size of the high capacity compact vacuum generating pump and its capability to provide the airflow equivalent to a centrifugal vacuum pump and vacuum generating capability of a rotary vane pump, the high capacity compact vacuum generating pump may be self contained within a modular package. Unlike a centrifugal pump or rotary vane pump, the high capacity compact vacuum generating pump, as an entirely self contained vacuum generating system, may be coupled to a machine vending positioning structure without the need for vacuum hoses. The high capacity compact vacuum generating pump requires no vacuum hoses or additional components to manage the hose. The present pump is coupled in its entirety to a positioning structure. One example of a positioning structure is a multi-segmented robotic arm, or a linear carriage system moveable in one or more directions, or combination there of. However, because the present pump is self contained, it generates a torque when energized that is transferred to its housing and can cause the pump to rotate, particularly when it is attached to a positioning structure through the use of a reel and cable system. Accordingly, a garage, attached to the positioning structure, is utilized to receive the pump and prevent the pump from rotating about its attachment cable.

The preferred embodiment of coupling the high capacity compact vacuum generating pump to the positioning structure is through an electrical conductor that is constructed to support the physical load of the high capacity compact vacuum generating pump as well as provide electrical power. The coupling mechanism is an electrical connection and mechanical connection allowing toolless attachment to and removal from the positioning structure.

### BRIEF DESCRIPTION OF THE DRAWINGS

FIG. 1A is an angled cross-sectional view of one embodiment of the pump assembly.

FIG. 1B is a straight on cross-sectional view of one embodiment of the pump assembly.

FIG. 1C is a enlarged view of part of the pump assembly embodiment of FIG. 1B.

FIG. 2 is a depiction of the garage utilized in conjunction with the pump assembly.

FIG. 3A is a cross-sectional view of the top of the discharge plate of one embodiment of the pump assembly.

FIG. 3B is a cross-sectional view of the bottom of the discharge plate of one embodiment of the pump assembly.

FIG. 4A is a cross-sectional view of the top of the intake plate of one embodiment of the pump assembly.

FIG. 4B is a cross-sectional view of the top of the intake plate of one embodiment of the pump assembly.

FIG. 5A is a view of the rotor of one embodiment of the pump assembly depicting the top of the rotor.

FIG. 5B is a view of the rotor of one embodiment of the pump assembly depicting the bottom of the rotor.

FIG. 5C is a top-down cross sectional view one embodiment of the pump assembly depicting the top of the rotor within the vacuum generating chamber.

FIG. 6A is a depiction of one embodiment of a pump assembly including a robotic manipulator and garage.

FIG. 6B is a cross sectional view of one embodiment of a pump assembly including a robotic manipulator and a garage.

FIG. 7 is a depiction of the reel and sensor utilized in one embodiment of a pump assembly.

FIG. 8 is a diagram of a one embodiment of a controller that controls the manipulation of the pump assembly.

FIG. 9 is a depiction of a cross section of one embodiment of the garage.

### DETAILED DESCRIPTION OF THE PREFERRED EMBODIMENTS

The preferred embodiments of the present invention are described with reference to the drawings below. In the drawings, like numbers are used to refer to like elements.

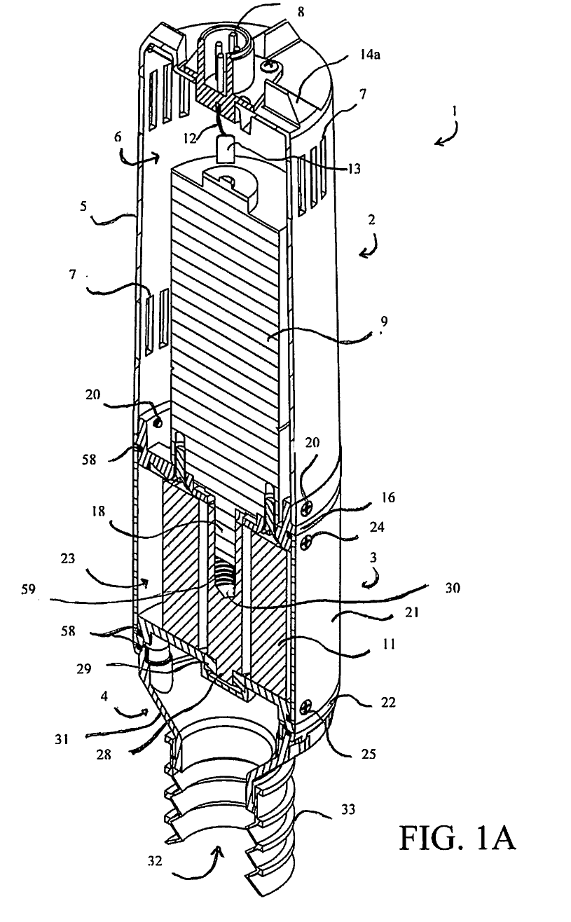

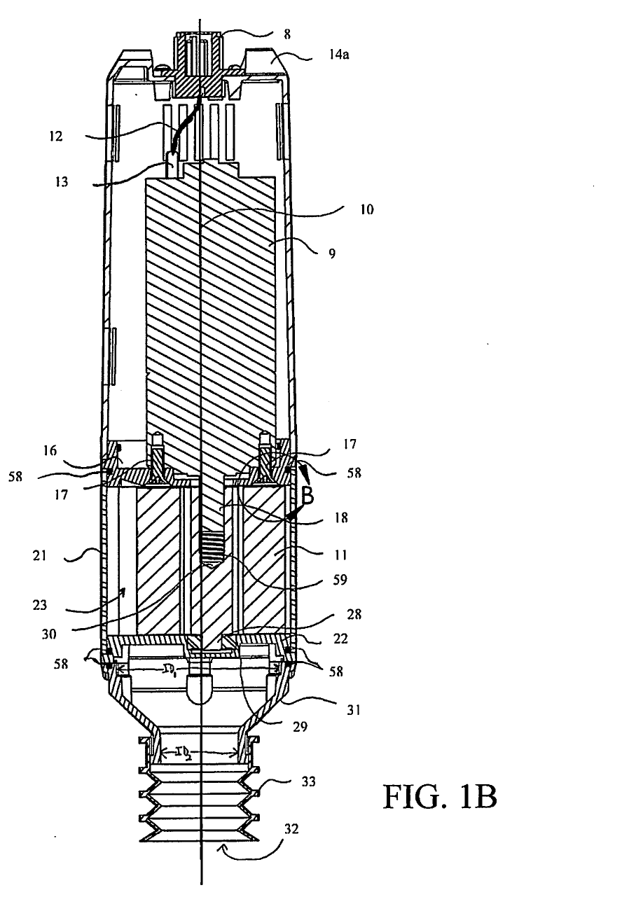

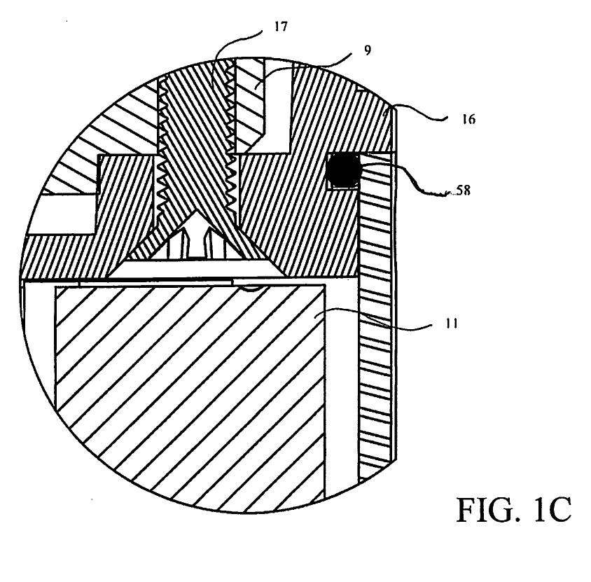

A bisected view of a preferred embodiment of the pump assembly is provided in FIG. 1A. The pump 1 is comprised of a housing that has three basic sections, an upper housing 2, a vacuum generating section 3, and a lower intake section 4. The upper housing 2 includes an upper housing wall 5 which defines a hollow upper housing chamber 6. Exhaust vents 7 are provided in the upper housing wall 5 to allow for gas to escape the system. Attached to the top of the upper housing is a coupling 8. Preferably, the coupling provides both a mechanical and electrical connection between the pump 1 and a manipulator. In one embodiment, the manipulator is attached to the coupling by a cable that provides mechanical support to move the pump in various directions, such as up and down, and transmits electrical power to the pump to activate the motor 9 of the pump. In the embodiment shown in FIG. 1B, the coupling is located coaxially with the longitudinal center axis 10 of the pump 1.

A conductor 12, such as a cable, electrically connects the coupling 8 to the motor 9. The conductor supplies power to the motor in order to control the motor. In the preferred embodiment, a temperature limit switch 13 is connected in series with the conductor 12 supplying the power to the motor 9 such that if the temperature of the motor exceeds and upper threshold, the limit switch 13 opens and removes power from the motor.

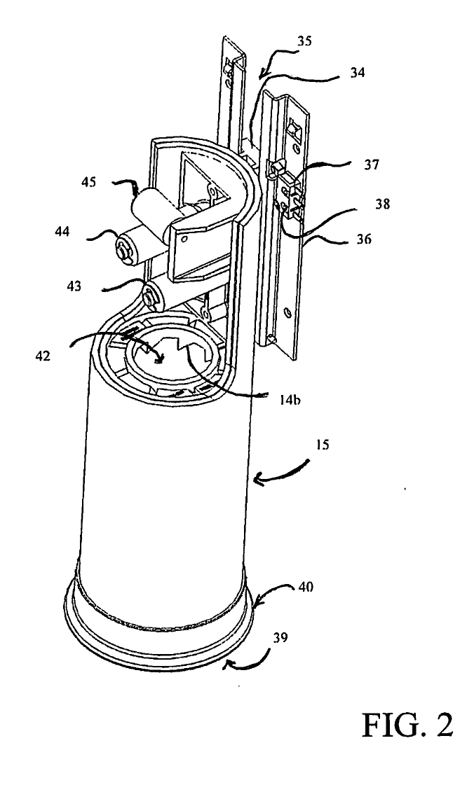

The upper housing 2 also includes one or more anti-rotation segments 14a. Preferably, the anti-rotation segments 14a are in the form or teeth that extend out from the upper housing wall 5. The anti-rotation segments 14a correspond to anti-rotation segments 14b, shown in FIG. 2, located on the garage 15. In practice, the segments 14a and 14b mate with each other such that a rotational force transmitted by the motor 9 to the upper housing 2, and hence segments 14a, when the motor 9 is activated, is inhibited by segments 14b through contact with 14a. It should be appreciated that the anti-rotation segments 14a and 14b are each depicted as male segments that protrude from a surface, but either 14a or 14b could alternatively be a female segment that is recessed into a surface where the other segment is a male segment adapted to fit into the female recess. In the preferred embodiment the anti-rotation segments 14a and 14b are triangular in shape so as to allow the rotation of the pump 1 in one direction, but not the other. As such, the anti-rotation teeth provide a lead in mesh much like gears.

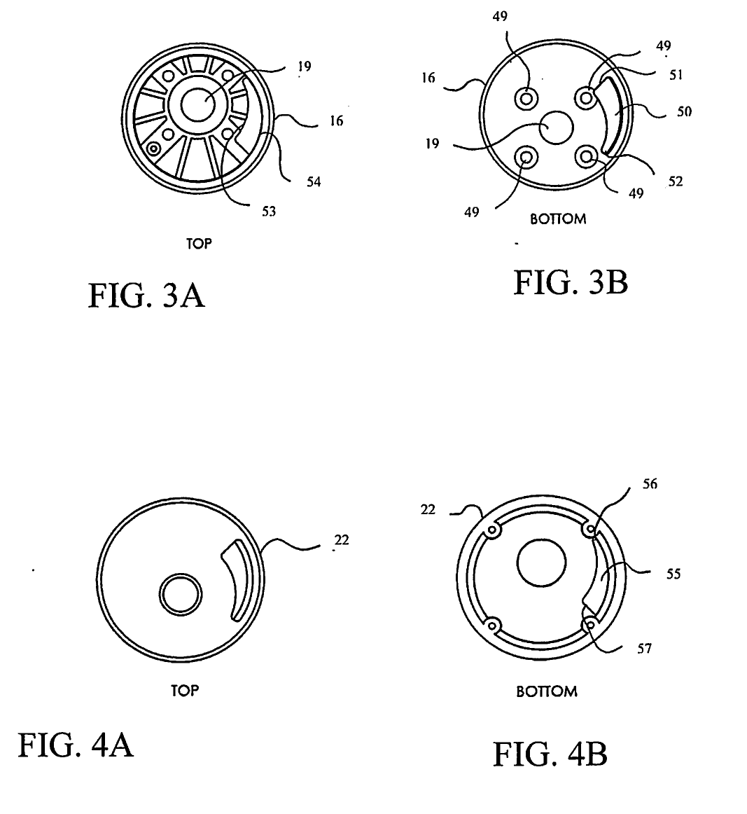

At the base of the upper housing is the air discharge plate 16. The motor 9 is located within the upper housing and is fastened to the air discharge plate 16 by fasteners, for example by screws 17 shown in detail in FIG. 1C. Motor 9 includes a motor shaft 18 that extends through the air discharge plate through a shaft orifice 19, shown in FIGS. 3A and 3B, in the air discharge plate 16.

The upper housing wall 5 is secured directly to the air discharge plate 16, and the joint between the two is sealed with a gasket, such as an O-ring 58. O-rings 58 are preferably provided (as shown in FIG. 1B) between the upper housing 2, the vacuum generating section 3 and lower intake section 4. Preferably the upper housing wall is secured by one or more fasteners, such as upper housing fasteners 20 which may be temporary fasteners such as screws or permanent fasteners such as rivets. However, it is conceived that the upper housing could be connected to the plate by snap-fit engagement, threaded engagement such that the upper housing includes circumferential threads that mate with circumferential threads on the air discharge plate, welding or chemical bonding or a combination of the foregoing.

The vacuum generating section 3 is defined by the air discharge plate 16 at the top, the vacuum chamber 21 and the air intake plate 22 which collectively define a vacuum generating chamber 23. Preferably, the vacuum chamber 21 is connected to the air discharge plate 16 and the air intake plate 22 in the same manner as the upper housing is connected to the air discharge plate. In the embodiment depicted in FIG. 1A, the vacuum chamber 21 is connected to the air discharge plate 16 by a first set of vacuum chamber fasteners 24, and is connected to the air intake plate 22 by a second set of vacuum chamber fasteners 25.

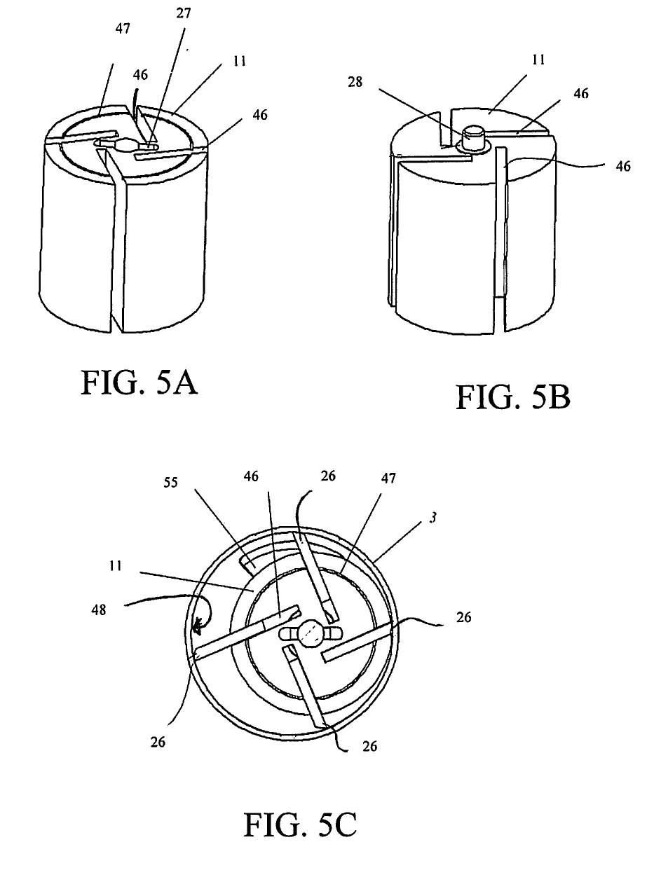

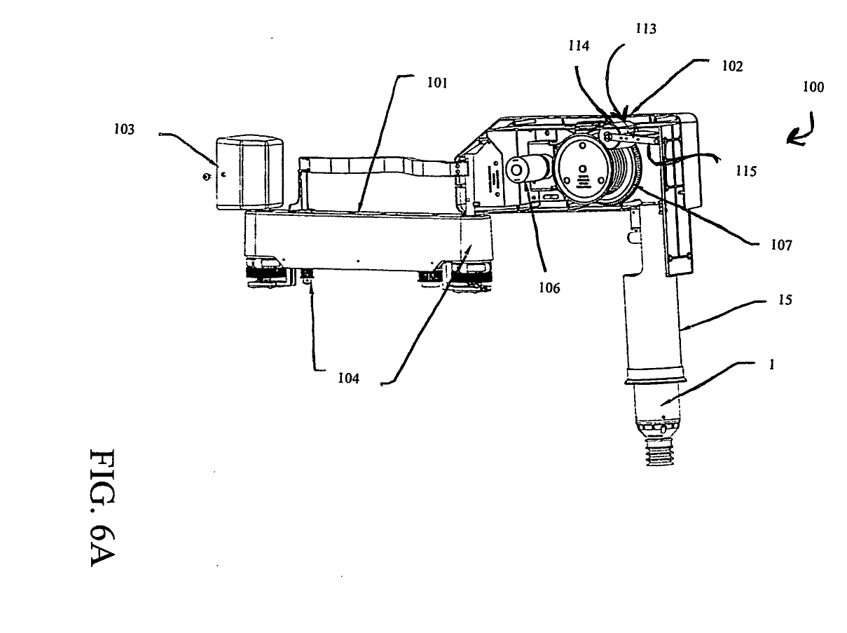

The vacuum generating chamber 23 houses the rotor 11 of the vacuum. Rotor 11 is described with respect to FIGS. 5A to 5C, and generally includes a plurality vanes 26 which move to extend and contract radially from the center of the rotor. The rotor 11 is further mounted to the motor shaft 18 such that rotation of the motor shaft 18 rotates the rotor 11. As show in in FIG. 5A, the rotor includes a shaft slot 27 that accommodates a keyed motor shaft of the motor. It is preferred that the rotor 11 is not fixed to the motor shaft 18, however. The rotor is coupled to a rotor axle 28 which rotates within a rotor bearing 29 that is coupled to the air intake plate 22. Thus, the rotor 11 is supported by the air intake plate 22 and the orientation of its axis is maintained within the vacuum generating chamber 23 by the rotor axel 28 and the motor shaft 18. A biasing spring 59 is fitted within the motor shaft bore hole 30 in the rotor and transmits a biasing force between the rotor 11 and the motor shaft 18 such that as the components of the system expand and contract, due to fluctuations in temperature for example, the biasing spring maintains tension between the rotor 11 and the motor shaft 18 while allowing the rotor 11 to slide up and down the motor shaft 18. During operation, the rotor 11 slides along the motor shaft 18, but is bounded in its movement by the air discharge plate 16 at the top and the air intake plate 22 at the bottom. In the preferred embodiment, the spring provides sufficient tension between the rotor 11 and the motor shaft 18 so that the rotor is prevented from contacting the surface of the air discharge plate. The spring biases the rotor toward the air intake plate so as to maintain a critical gap (not shown) between the rotor and the air intake plate. In the preferred embodiment, the critical gap is approximately 0.008 inches. The gap ensures that a proper vacuum can be generated within the vacuum generating chamber wile also ensuring that the rotor does not seize through contact with the intake plate as the dimensions of the components of the rotor fluctuate due to heat. Thus, the biasing spring 59 ensures that rotor 11 floats between the air discharge plate 16 and air intake plate 22 during operation of the pump.

As shown in FIGS. 1A and 1B, the pump 1 also includes lower intake section 4 which includes intake cone 31. Preferably, intake cone 31 is connected to the air intake plate 22 and in the same manner as the upper housing wall 5 is connected to the air discharge plate 16. In the embodiment depicted in FIG. 1A, the intake cone 31 is connected to the air intake plate 22 by a set of intake cone fasteners (not shown). The air intake cone 31 defines a cavity having a wider upper section that tapers as it extends downward toward an air inlet 32. Thus, the internal dimension ID₁ of the air intake cone 31 at the junction between the air intake cone 31 and the air intake plate 22 is greater than the internal dimension ID₂ of the air intake cone at the air inlet 32. Preferably, a suction cup 33 is attached to the intake cone 31 at the air inlet.

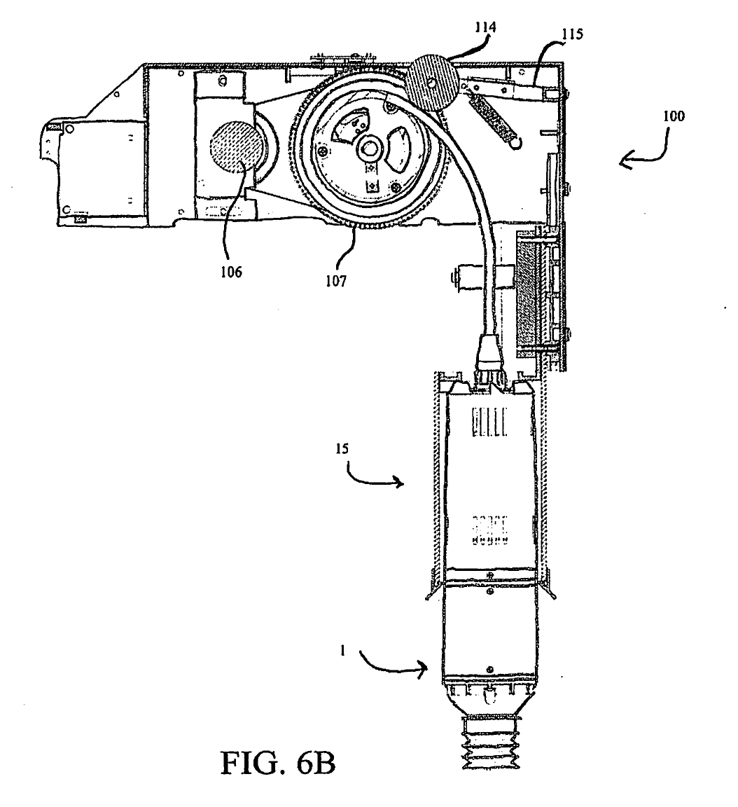

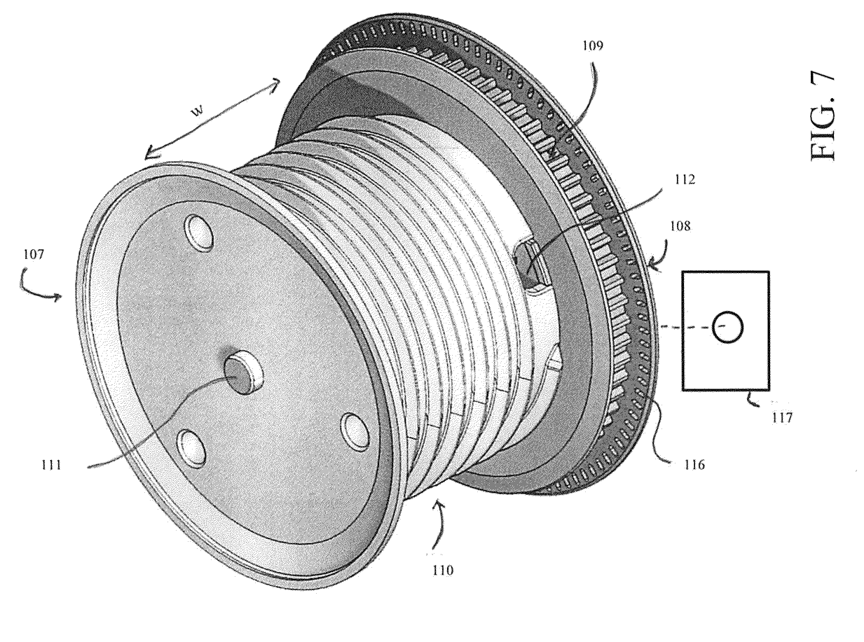

As shown in FIGS. 6A and 6B, the pump 1 may be coupled to a manipulator which moves the pump from location to location in order to temporarily couple the pump to a product which is then picked up by the vacuum of the pump and moved to a location where the product is decoupled from the pump. In the preferred embodiment, the manipulator is a robotic arm 100 as shown in FIG. 6A. The robotic arm 100 includes segments such as a main arm 101, a fore arm 102 and a mount 103 connected together by joint drives 104. As the joint drives rotate, each moves the segments of the robotic arm and in turn alters the location of the pump 1. The robotic arm 100 may be mounted to a structure (not shown) by mount 103. The fore arm 102 further includes a reel drive 106 and reel assembly 107. The reel assembly 107 includes a reel cable (not shown) that spools around the reel assembly and is connected at one end to pump 1. Preferably, the reel cable includes both a mechanical and electrical connection and is coupled to the pump by coupling 8. One end of the fore arm 102, the proximal end, is joined to the main arm 101, while the other end, the distal end, the fore arm 102 is provided with a garage 15 that houses the pump 1 when the pump 1 is fully retracted.

As shown in FIG. 2, the garage 15 is generally in the shape of an elongated tube having an orifice at either end. The garage 15 includes a coupling member 34, such as a rail or “T” guide, that mates with bracket slide 35 of a mounting bracket 36. It should be appreciated that either the slide 35 or coupling member 34 could be male or female though a male coupling member 34 and female slide 35 are depicted. The coupling member 34 is attached to the garage 15 and slides up and down within bracket slide 35. The mounting bracket 33 is in turn mounted to the distal end of the fore arm 102. Thus the garage 15 may be adjusted by sliding the garage and coupling member 34 within the bracket slide 35.

In the preferred embodiment, a positioner 37, such as an electrical motor, is coupled to the mounting bracket 36 or coupling member 34 such that it moves the garage 15 up and down, positioning it along the mounting bracket 36. Where positioner 37 is an electrical motor, control signals from a controller electrically connected to the positioner 37 are used to control the positioner 37 and position the garage 15. Additionally, the positioner 37 is also provided with one or more feedback sensors 38. Such sensors could include an encoder or resolver that translates the position of a rotary motor within the positioner into an identification of the location of the garage. Alternately, position sensors such as optical sensors, mechanical sensors, or magnetic sensors for example, may be located on the garage 15, coupling member 34 or mounting bracket 36 and provide feedback either directly to the positioner 37 or to the controller for the positioner indicating the relative position of the garage 15 with respect to a reference point such as a point on the mounting bracket or the distal end of the fore arm 102, for example.

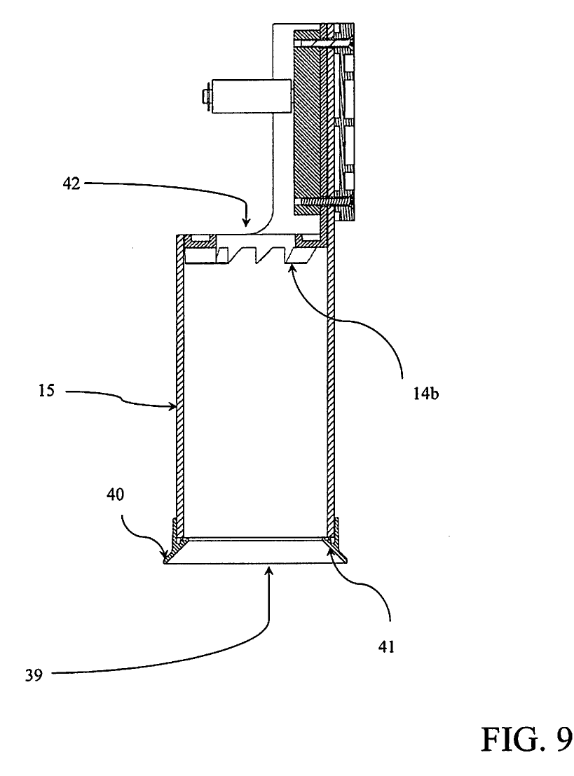

The lower orifice 39 of the garage is wide enough to accommodate the pump 1 such that as the reel assembly 107 draws in the cable, the pump slides into the garage. Preferably, as shown in FIG. 9, the lower orifice 39 is defined by a guide ring 40 having a tapered surface 41 that angles inward toward the center of the garage. The upper orifice 42 is rimmed with anti-rotation segments 14b. As the pump 1 is drawn into the garage, the internal sidewalls of the garage maintain the proper orientation of the pump and prepare the anti-rotation segments 14a located on the pump to engage the anti-rotation segments 14b of the garage. When fully retracted, the anti-rotation segments 14a and 14b nest with each other while the upper orifice 42 allows the coupling 8 to extend out of the garage and prevents the coupling 8 from impeding the nesting contact between anti-rotation segments 14a and 14b.

Garage 15 further includes a plurality of cable rollers 43, 44 and 45. Preferably, the axis of roller 45 is parallel to the axis of the reel 107 that winds the cable while the axes of the rollers 43 and 44 are parallel to each other but offset so as to accommodate the cable between rollers 43 and 44. The cable connecting the reel 107 and the pump 1 is wound through the rollers such that as the reel extends and contracts the length of the cable, the rollers maintain the cable, and hence the pump, in a position substantially along the longitudinal center axis line of the garage. Thus, even as the cable traverses along the width W of the reel 107, show in FIG. 7, the cable, and hence the pump 1, remain axially aligned with the garage which ensures that the pump properly retracts into, or docks with, the garage without catching on the lower orifice guide ring 40. To facilitate docking the pump 1 with the garage 15, it is preferable that the upper housing wall 5 be slightly conical, where the base of the upper housing wall 5 which connects to the air discharge plate 16 is wider than the top portion of the upper housing wall which includes the anti-rotation segments 14a. Similarly, it is preferable that the garage 15 is also slightly conical where the base of the garage which includes the lower orifice 39 is wider than the top of the garage which includes the upper orifice 42. The conical shapes of the pump 1 and garage 15 facilitate docking by guiding the pump into the garage and also prevent the pump from engaging the guide ring 40 and becoming stuck as it is retracted into the garage.

FIGS. 1A, 1B and 5A to 5C provide depictions of the vacuum generating section 3 and the rotor 11. As shown in FIG. 1A, the rotor is mounted within the vacuum generating section 3 between the air intake plate 22 and air discharge plate 16 such that the longitudinal center axis of the rotor, which is coaxial to the motor shaft 18, passes through the two plates. Additionally, the longitudinal center axis of the rotor is offset from the overall longitudinal center axis 10 of the pump 1. Thus the rotor 11 is offset from the longitudinal center axis of the vacuum generating section 3, which, in FIG. 1B is coaxial with the axis 10. In the preferred embodiment the motor 9, motor shaft 18, and rotor 11 are all coaxial with each other and offset from the longitudinal center axis 10 of the pump 1.

The rotor 11 is cylindrical in shape having a width corresponding to the diameter of the cylinder and a length. The rotor 11 includes vane cavities 46, vanes 26 and a rotor bypass groove 47. It is contemplated that rotor bypass groove 47 may be formed in either or both the upper and lower planar surfaces of the rotor 11, though it is preferable that it is formed in the upper planar surface and formed such that it is concentric with the circumference of the rotor 11. Generally, each rotor vane 26 is rectangular in shape having dimension that are approximately equal to the dimensions of the vane cavities 46. Preferably, the height of the each vane, when the rotor is cold and stationary, reaches the top of the rotor or slightly above the top or the rotor, but not so high that it contacts the air discharge plate 16 which could cause the rotor to bind. It is also preferable that the height of each vane is no lower than the bottom of the rotor bypass groove 47 in order to ensure that proper compression and suction is achieved. The thickness of each vane is slightly smaller than the thickness of its vane cavity such that the vanes slide smoothly in and out of the vane cavities. Preferably the outer edge of each vane is curved and the curve of that edge approximates the curve of the inner surface 48 of the vacuum chamber 21. As the rotor 11 rotates, the vanes 26 slide in and out of the vane cavities 46 and their curved outer edges slide along the inner surface 48 of the vacuum chamber 21. That motion creates a pressure differential that draws air in through the air intake plate 22, forces the air to traverse the length of the rotor, and then forces the air out through the air discharge plate 16.

FIGS. 3A through 4B depict the top and bottom of the air discharge plate and the top and bottom of the air intake plate, respectively. In the preferred embodiment, the air discharge plate 16 includes mounting holes 49 for mounting the motor 9 (not shown) to the air discharge plate 16 and a shaft orifice 19 that allows the motor shaft 18 (not shown) to pass through the air discharge plate. The shaft orifice 19 is offset from the center of the air discharge plate 16. Additionally, the air discharge plate includes an air discharge port 50 that allows air to pass from the vacuum generating chamber 23 to the upper housing chamber 6. Preferably, the air discharge port 50 is in the shape of a half crescent having a thick end 51 that curves and tapers to a termination point 52. It is further preferred that the interior curve 53 of the discharge port 50 mirrors the circumferential curve of the rotor 11 while the exterior curve 54 minors the circumferential curve of the air discharge plate 16. Similarly, the air intake plate 22 preferably includes an air intake port 55 having a half crescent shape like that of the air discharge port 50 that allows air to pass from the intake cone 31 to the vacuum generating chamber 23. In the preferred embodiment, the air discharge port 50 and air intake port 55 are vertically aligned but the orientation of the air discharge port 50 is reversed with respect to the air intake port 55 such that the thick end 51 is locate above the termination point 56 of the air intake port 55 while the termination point 52 is located above the thick end 57 of the air intake port 55.

To create the vacuum, incoming air enters the pump and it is drawn into the cylinder by the rotating vanes. As the rotor turns the sliding vanes seal and compresses the air as the volume between the vanes, rotor and vacuum chamber inner surface is reduced. After maximum compression is achieved the air exists through the air discharge port 50. The bypass grove 47 allows the pump to run cooler since the some of the air is not compressed, but rather re-circulates in the chamber.

As discussed above, the pump 1 is coupled to a cable through coupling 8. The cable is in turn connected to a reel 107 forming a reel and cable assembly that raises and lowers the pump 1. Referring to FIGS. 6 and 7, the reel assembly includes a cylindrical reel 107, a reel drive 106, a flange 108, a belt guide 109 a helical guide surface 110, all of which rotate about a rotational axis 111. Preferably, the reel also includes a cable port 112 through which a cable (not shown) is threaded and secured to the interior of the reel 107. The helical guide surface 110 is distributed along the width “W” of the reel such that it guides the cable along the width as the reel rotates to spool the cable, distributing it uniformly along the reel. A tensioner pulley 113 is connected to the arm and applies pressure to the reel and cable assembly thereby guiding the cable as it spools onto the reel and ensuring the cable lays properly on the reel. The tensioner pulley 113 is preferably a wheel 114 attached to a pivoting arm 115. The tensioner pulley 113 may be of sufficient weight to properly tension the cable or the tension can be increased by coupling one or more springs (not shown) to the tensioner pulley where the springs force wheel 114 of the tensioner pulley 113 against the reel and cable. The reel is coupled to a reel drive 106, such as a motor, through a drive belt (not shown) which lies within the belt guide 109 of the reel. Preferably, the position of the drive motor and reel are adjustable with respect to one another in order to provide the proper tension on the drive belt. Alternately, another tensioning arm may be provided to provide tension to the drive belt.

The reel and cable assembly is also provided with a positional sensor. Preferably, the flange 108 of the reel 107 is provided with a plurality of tic marks, one of which is identified in FIG. 7 as 116, where the tic marks are preferably evenly distributed about the circumference of the flange 108. As shown in FIG. 7, the tic marks are holes that pass through the flange. A reel sensor 117 is positioned proximate to the reel 107 for sensing the tic marks. The reel sensor provides feedback to a controller 118 such that the controller can identify one or more of the rotational position and velocity of the reel. It should be apparent that a variety of different tic marks and reel sensor combinations could be utilized. For example, the tic mark and reel sensor combination could comprise a plurality of reflective marks and an optical sensor or could be a plurality of magnetic sites together with a proximity sensor. Thus, as the reel turns, the reel sensor senses the tic marks and generates electrical signals in response.

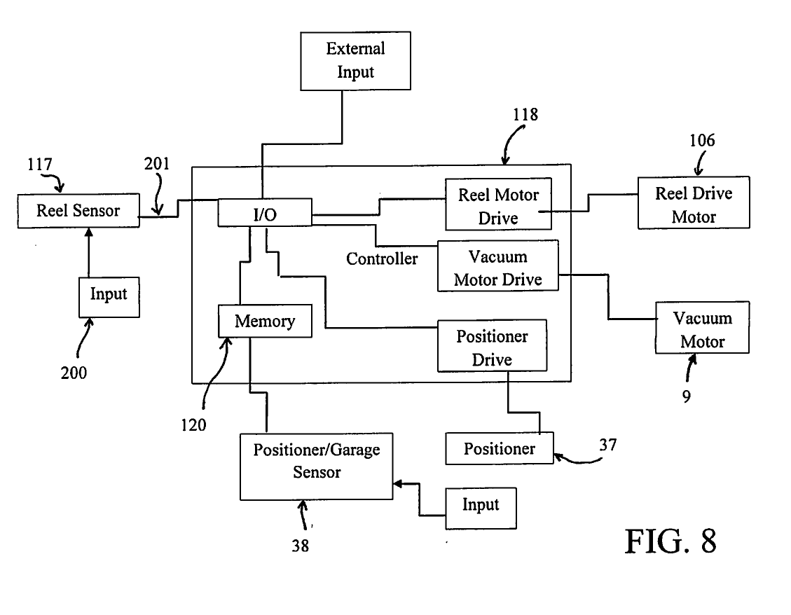

The manipulator, reel and cable assembly and pump are also provided with a controller for controlling the operation of each of the arm, reel and cable assembly and pump. The controller may be a single controller for controlling each of the forgoing or a number of discrete controllers which work together to control the various devices such as the arm, reel and cable assembly and pump. In FIG. 8, a single controller is utilized for explanative purposes. With respect to the operation of the reel and cable assembly, as the reel 107 is turned by reel drive 106, the reel sensor 117 senses the tic marks as inputs 200, generates electrical signal pulses 201 in response to sensing the tic marks and transmits those signal pulses to a controller 118 which includes input for receiving signals and output for sending signals (I/O). The signals 201 provide the controller with information regarding rotation of the reel 107. Preferably, the controller counts the pulses and then calculates the rotational position of the reel. The rotational position of the reel may then be used by the controller to calculate the length of the cable spooled onto the reel and the vertical position of the pump which is a function of the overall length of the cable connecting the pump and reel assembly and the amount of cable spooled onto the reel. The vertical position of the suction cup 33 may further be obtained be the controller by taking into account the overall length of the pump 1 in addition to the length of the cable. In the preferred embodiment, the controller includes a memory 120. The vertical positions of the pump, a function of the electrical signal pulses transmitted by the reel sensor 117, are stored in the memory of the controller. The memory also stores the maximum vertical distance limits of the pump, such distances also being a function of the electrical signal pulses generated by the reel sensor.

In the case of use in a vending machine or similar application, the memory also stores information about the products to be vended, such as the thickness of products to be vended as well as the number of products in particular stacks of products to be vended, each as a function of signal pulses of the sensor and reel combination. Thus, the controller can calculate the vertical distance between the pump and a particular product to be vended as a function of the electrical signal pulses of the reel sensor. Once a particular product is vended, its thickness is accounted for by the controller such that when the next product in the stack is vended, the controller calculates a new vertical travel distance that the pump 1 must traverse, the new distance including the thickness of the previously vended product. Thus, for each vending cycle, the distance the pump 1 must travel in the new vending cycle, and hence the rotational position of the reel, are calculated by the controller on the basis of the electrical signal pulses generated by the reel sensor as during previous vending cycles. Similarly, the velocity of the pump 1 is calculated based on the electrical signal pulses generated by the reel sensor. The number of signal pulses generated in a period of time provides the velocity of the reel assembly. The controller utilizes that information to calculate the vertical translational velocity of the pump 1. The controller then modulates the power to the reel drive 106 in order to adjust the velocity of the pump 1 to meet a target velocity for the pump. The target velocity is stored in the memory of the controller and the controller compares the calculated velocity of the pump 1 to the target velocity and modulates the power to the reel drive 106 accordingly.

In the preferred embodiment, the memory of the controller stores a number of different target velocities such as a target velocity for contact with a product to be vended, a target velocity for mating with the garage, and a target velocity for translating the distance between the garage and the product to be vended. During a vending cycle, the controller utilizes the electrical signal pulses generated by the reel sensor to determine the position of the pump as well as the velocity of the pump. The sensed position and velocity are compared to predetermined target velocities over different position ranges. The controller then modulates the power to the drive motor 106 in order to reach the target velocity for the pump 1 in a particular positional range. As products are vended through vending cycles, the controller updates the target velocities and positional ranges to account for the absence of the vended products.

Although the present invention has been described in terms of the preferred embodiments, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

What is claimed is:

1. pump assembly comprising:
an upper housing, an air discharge plate, a vacuum generating section, and air intake plate and a lower intake section, a motor housed within said upper housing and having a motor shaft that passes through said air discharge plate and into said vacuum generating section, a rotor housed within said vacuum generating section, said rotor having a center axis and said rotor being coupled to said motor shaft such that a center axis of said motor shaft is congruent with said center axis of said rotor, and wherein rotation of said motor shaft causes the rotor to rotate;
said rotor further including a rotor bottom and rotor top each having a diameter, a rotor side having a length along said center axis such that said length is greater than said diameter, at least one vane cavity extending from said bottom to said top, at least one vane being of substantially the same size as said vane cavity and housed within said vane cavity such that said vane slides within said vane cavity;
said vacuum generating section further includes a center axis, and wherein the center axis of the said rotor is parallel to the center axis of the vacuum generating chamber and the center axis of said rotor is offset from the center axis of the vacuum generating chamber, said air intake plate further includes an air intake port having a thick end that tapers to a termination point,
said air discharge plate further includes an air discharge port having a thick end that tapers to a termination point,
wherein said air intake plate, vacuum generating section and air discharge plate form a vacuum generating chamber such that said air intake plate is disposed opposite said air discharge plate and said air intake plate is oriented such that the air intake port is not directly below the air discharge port.

2. A pump assembly as in claim 1 wherein said rotor further comprises a motor shaft bore hole, a rotor axle, and a spring within said motor shaft bore hole such that said spring biases said rotor toward said air intake plate.

3. A pump assembly as in claim 1 wherein said at least one vane cavities have a height equal to the length of said rotor, a width and wherein said vane includes a height, length and width corresponding to said vane cavity height length and with, and wherein an outer side of said vane is curved.

4. A pump assembly as in claim 3 wherein said rotor further includes a rotor bypass grove having a bottom and wherein the height of said vane is greater than the distance between said air intake plate and said bottom of said rotor bypass groove and less than the distance between the air intake plate and the air discharge plate.

5. A pump assembly as in claim 4 further including at least four vanes.

6. A pump assembly as in claim 1 further comprising a thermal limit switch connected in series between the motor and a power supply for the motor.

7. A pump assembly as in claim 6 further comprising a garage, said garage including an upper orifice and a lower orifice, said lower orifice defined by a guide ring wherein at least a portion of said upper housing nests within said garage.

8. A pump assembly as in claim 7 wherein said garage is conical in shape such that a diameter of said upper orifice is smaller than a diameter of said lower orifice and wherein said guide ring includes a tapered surface that angles inward toward the center of the garage.

9. A pump assembly as in claim 7 further comprising an adjustable bracket mounted to said garage, a controller and a positioner wherein said controller sends control signals to said positioner and said positioner adjusts the position of said garage in response to said control signals.

10. A pump assembly as in claim 7 further including at least three rollers, wherein two of said rollers are oriented parallel to each other and a third roller is oriented perpendicular to said two parallel rollers.

11. A pump assembly as in claim 7 wherein said garage includes at least one anti-rotation segment, said upper housing includes at least one anti-rotation segment corresponding to said anti-rotation segment of said garage and wherein the anti-rotation segment of said garage contacts the anti rotation segment of said upper housing when said upper housing nests within said garage.

12. A pump assembly as in claim 7 further including a robotic arm having at least on arm segment, an arm motor operably connected to a proximal end of said arm segment which moves said arm segment, wherein said garage is connected to a distal end of said arm segment.

13. A pump assembly comprising:
An arm having a proximal end and a distal end,
at least one controller,
an arm motor, operably connected to said proximal end of said arm and which moves said arm,
a reel connected to said arm, a reel motor operably connected to said reel, and a cable wound around said reel,
a garage connected to said distal end of said arm,
a vacuum pump comprising an upper housing, an air discharge plate, a vacuum generating section, and air intake plate and a lower intake section, a vacuum motor housed within said upper housing and having a motor shaft that passes through said air discharge plate and into said vacuum generating section, a rotor housed within said vacuum generating section, said rotor having a center axis and said rotor being coupled to said motor shaft such that a center axis of said motor shaft is congruent with said center axis of said rotor, and wherein rotation of said motor shaft causes the rotor to rotate;
said rotor further including a rotor bottom and rotor top each having a diameter, a rotor side having a length along said center axis such that said length is greater than said diameter, at least one vane cavity extending from said bottom to said top, at least one vane being of substantially the same size as said vane cavity and housed within said vane cavity such that said vane slides within said vane cavity;
said vacuum generating section further includes a center axis, and wherein the center axis of the said rotor is parallel to the center axis of the vacuum generating chamber and the center axis of said rotor is offset from the center axis of the vacuum generating chamber,
said air intake plate further includes an air intake port having a thick end that tapers to a termination point,
said air discharge plate further includes an air discharge port having a thick end that tapers to a termination point,
wherein said air intake plate, vacuum generating section and air discharge plate form a vacuum generating chamber such that said air intake plate is disposed opposite said air discharge plate and said air intake plate is oriented such that the air intake port is not directly below the air discharge port; and wherein
said cable is also connected to said upper housing and said at least one controller controls the operation of said arm motor, said reel motor and said vacuum motor.

14. A pump assembly as in claim 13 further comprising an adjustable bracket connected to said garage and said arm and a garage motor operably connected to said bracket and controlled by said controller such that a control signal sent by said controller to said garage motor causes said garage motor to adjust the position of said garage.

15. A pump assembly as in claim 13 wherein said controller includes a memory storing information regarding products in proximity to said pump assembly wherein said information is a function of the position of said reel.

16. A pump assembly as in claim 13 further comprising a reel sensor; wherein said reel includes a plurality of tic marks and said reel sensor senses said tic marks and generates signals in response to sensing said tic marks, said signals being sent to said controller and wherein said controller calculates the position of said vacuum pump based on said signals.

17. A pump assembly as in claim 13 further comprising a thermal limit switch connected in series between the vacuum motor and a power supply for the motor.
